(19) United States
(12) Patent Application Publication
(10) Pub. No.: US 2025/0358806 A1
(43) Pub. Date: Nov. 20, 2025

(54) MULTI-NON-TERRESTRIAL NODE BEAM CONFIGURATION

(71) Applicant: Huawei Technologies Co., Ltd., Shenzhen (CN)

(72) Inventors: Jalal Khamse-Ashari, Stittsville (CA); Amine Maaref, Ottawa (CA)

(21) Appl. No.: 19/236,543

(22) Filed: Jun. 12, 2025

Related U.S. Application Data
(63) Continuation of application No. PCT/CN2022/139571, filed on Dec. 16, 2022.

(51) Int. Cl. H04W 72/044; H04W 16/28; H04W 72/51; H04W 72/542

(52) U.S. Cl. CPC H04W 72/046; H04W 16/28; H04W 72/51; H04W 72/542

(57) ABSTRACT

According to implementations, a UE may obtain measurements for signals received over different elevation angles. Subsequent to obtaining the measurements, the UE may transmit a feedback report including at least one of indications of the measurements, indications of UE capabilities as well as indications regarding constraints on beam directions. Upon receipt of feedback reports from a plurality of UEs, a network node may configure a UE-centric BTC for each UE in the plurality of UEs and then transmit UE-centric BTC configuration information to each UE for communicating at least one of physical signals and physical channels.

### CROSS-REFERENCE TO RELATED APPLICATION

This application is a continuation of International Application No. PCT/CN2022/139571, filed on Dec. 16, 2022, and titled “MULTI-NON-TERRESTRIAL NODE BEAM CONFIGURATION,” which is hereby incorporated by reference in its entirety.

### TECHNICAL FIELD

The present disclosure relates to wireless communications, generally, to beam configuration in wireless communication networks and, in particular embodiments, to multi-satellite beam configuration.

### BACKGROUND

Transmit-receive points for mobile wireless communication networks are often both fixed in their location and land-based. However, strides are being made to allow satellites to provide service as a transmit-receive point in a mobile wireless communication network. Some such satellites may be geo-stationary and, as such, may require little in the way of adjustment to illuminate a fixed target coverage area on earth with a particular beam. It follows that non-geo-stationary satellites may be expected to handle some complex operations to consistently illuminate a fixed target coverage area on earth with a particular beam. Earth-fixed beam deployment is a name for a known method of deploying beams for use by non-geo-stationary satellites. In particular, a satellite implementing earth-fixed beam deployment may be shown to adaptively adjust a direction for a projected beam, so that the projected beam illuminates a fixed target coverage area on earth.

### SUMMARY

A user-equipment-centric (UE-centric) approach to determining UE-centric beam transition cycle (BTC) configuration information and then implementing the UE-centric BTC configuration information may be accomplished by exploiting a beam diversity that is understood to be provided as a consequence of having a plurality of satellites (of the same orbit or different orbits) within a line-of-sight of the UE in a LEO satellite mega constellation. The UE may obtain measurements for signals received over different elevation angles. Subsequent to obtaining the measurements, the UE may transmit a feedback report including at least one indication of the measurements, indications of UE capabilities as well as indications regarding constraints on beam directions. Upon receipt of feedback reports from a plurality of UEs, a network node may configure a UE-centric BTC for each UE in the plurality of UEs and then transmit UE-centric BTC configuration information to each UE for communicating at least one of physical signals and physical channels. The BTC configuration information for different UEs may allow for spectral efficiency to be optimized while respecting the various preferences/constraints associated with the plurality of UEs.

According to an aspect of the present disclosure, the physical signals may be downlink and/or uplink reference signals, such as CSI-RS and/or SRS, and the physical channels may be control channels and data channels, wherein the control channels may include PDCCH for downlink, PUCCH for uplink, or PSCCH for sidelink. The data channels may be PDSCH for downlink, PUSCH for uplink or PSSCH for sidelink.

As already discussed, a satellite signal may be blocked, may fail or may fade over certain elevation angles, while the satellite beam follows a fixed beam transition cycle. In response to a user equipment (UE) detecting a beam failure or a connection failure based on measurements of a reference signal received power, the UE may request a beam switching operation or a handover through a connection reestablishment procedure. Identifying a beam failure or connection switching event and, responsively, selecting a new beam or a new cell with which to re-establish a connection may be classified as “reactive, measurement-based procedures,” which may not only be shown to impose a considerable amount of overhead for measurements and signaling, but may also be shown to result in a connection that lacks robustness, due to a considerable latency caused by significant propagation delays to/from the satellites.

Aspects of the present application may be shown to exploit satellite diversity while optimizing spectral efficiency, thereby enhancing connection robustness.

Aspects of the present application may be shown to exploit knowledge of periodicity of beam transition cycles and may, by doing so, reduce signaling overhead for satellite beam switching, facilitate tracking of receive beam direction for the UE and facilitate satellite beam switching.

Those aspects of the present application that relate to the UE proactively sensing an environment and sending a feedback report may be shown to reduce likelihood of a beam failure.

Aspects of the present application may be shown to enable the UE and the network to respect various constraints on beam direction. The constraints on beam direction may be related to one or more of the UE capabilities, a maximum interference limit, channel conditions, maximum permissible Effective Isotropic Radiated Power, maximum transmission power, and others.

According to an aspect of the present disclosure, there is provided a communication method at a network side. The method includes transmitting, to a user equipment (UE), beam transition cycle (BTC) configuration information and communicating, from at least one non-terrestrial transmit-receive point (NT-TRP), at least one of physical signals and physical channels, with the UE, based on the BTC configuration information.

According to an aspect of the present disclosure, there is provided a method at a UE side. The method includes receiving, at a user equipment (UE), beam transition cycle (BTC) configuration information and communicating, at the UE, physical signals and physical channels, with at least one non-terrestrial transmit-receive point (NT-TRP), in accordance with the BTC configuration information.

According to an aspect of the present disclosure, there is provided a method at a network side. The method includes receiving, from a user equipment (UE), a feedback report and transmitting, to the UE, an indication of a selected common BTC, the selected common BTC selected based on the feedback report and from among a plurality of common BTCs.

According to an aspect of the present disclosure, there is provided a method at a UE side. The method includes selecting a common BTC among a plurality of common BTCs, thereby leading to a selected common BTC and operating in accordance with configuration information for the selected common BTC.

In a possible implementation, the BTC configuration information is signaled via RRC signaling, wherein the RRC signaling may be UE-specific RRC signaling, UE-group-specific signaling or common broadcast RRC signaling.

In a possible implementation, the BTC configuration information includes at least one of an indication of an initial beam direction, or an indication of a sequence of beam switching instants. The BTC configuration information may further include an indication of a sequence of beam indices corresponding to the sequence of beam switching instants.

In a possible implementation, the method at network side, further comprises a parameter including at least one of an identification of an orbit of a given NT-TRP among the at least one NT-TRP, maximum transition time for communication between the UE and the given NT-TRP, or minimum transition period for communication between the UE and the given NT-TRP.

In a possible implementation, the communicating comprises switching, at a switching time identified in the BTC configuration information, from a first serving beam to a second serving beam according to the BTC configuration information.

According to an aspect of the present disclosure, there is provided an apparatus comprising means for implementing the method at the network side shown above. The apparatus may be the NT-TRP or T-TRP or the beam management agent. The apparatus may be a component/module/chipset of the NT-TRP or T-TRP or the beam management agent.

According to an aspect of the present disclosure, there is provided an apparatus comprising means for implementing the method at the UE side shown above. The apparatus may be the UE. The apparatus may be a component/module/chipset of the UE.

According to an aspect of the present disclosure, there is provided a non-transitory computer readable storage medium, wherein the non-transitory computer readable storage medium stores instructions, and when the instructions run on a computer, the computer performs the method at the UE side or the method at the network side.

According to an aspect of the present disclosure, there is provided communication system comprising at least one apparatus implementing the method at the network side and at least one apparatus implementing the method at the UE side.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a known beam deployment from conventional low earth orbit satellite constellations;

FIG. 7 illustrates a building, a first UE and a second UE, a serving beam for both UEs is provided by a non-terrestrial transmit receive point;

FIG. 8 illustrates a scenario including a first non-terrestrial transmit receive point, a second non-terrestrial transmit receive point and a third non-terrestrial transmit receive point, all three of which may be understood to be part of a low earth orbit mega constellation and may be arranged to serve the first UE and the second UE, which are in the presence of the building that is familiar from FIG. 7;

FIG. 9 illustrates example steps of a method of determining UE-centric beam transition cycle configuration information, in accordance with aspects of the present application;

FIG. 10 illustrates example steps of a method for implementing UE-centric beam transition cycle configuration information, in accordance with aspects of the present application;

FIG. 11A illustrates a first example of a UE operating to adjust beam directions in accordance with a conventional beam transition cycle;

FIG. 11B illustrates a second example of a UE operating to adjust beam directions in accordance with a conventional beam transition cycle;

FIG. 11C illustrates a third example of a UE operating to adjust beam directions in accordance with a conventional beam transition cycle;

FIG. 11D illustrates an example of a UE operating to adjust beam directions in accordance with aspects of the present application;

FIG. 12 illustrates example steps in a method of a non-terrestrial transmit receive point providing beam transition cycle configuration information to a UE, in accordance with aspects of the present application;

FIG. 13 illustrates a flow diagram that provides an overview of signal flow amongst a beam management agent, a first non-terrestrial transmit receive point, a second non-terrestrial transmit receive point, a third non-terrestrial transmit receive point and a UE, in accordance with aspects of the present application;

FIG. 14 illustrates example steps in a method of providing UE-centric beam transition cycle configuration information to a UE; in accordance with aspects of the present application; and

FIG. 15 illustrates example steps in a method, carried out at a UE, for implementing UE-centric beam transition cycle configuration information, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those skilled in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data for executing the method in this disclosure. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

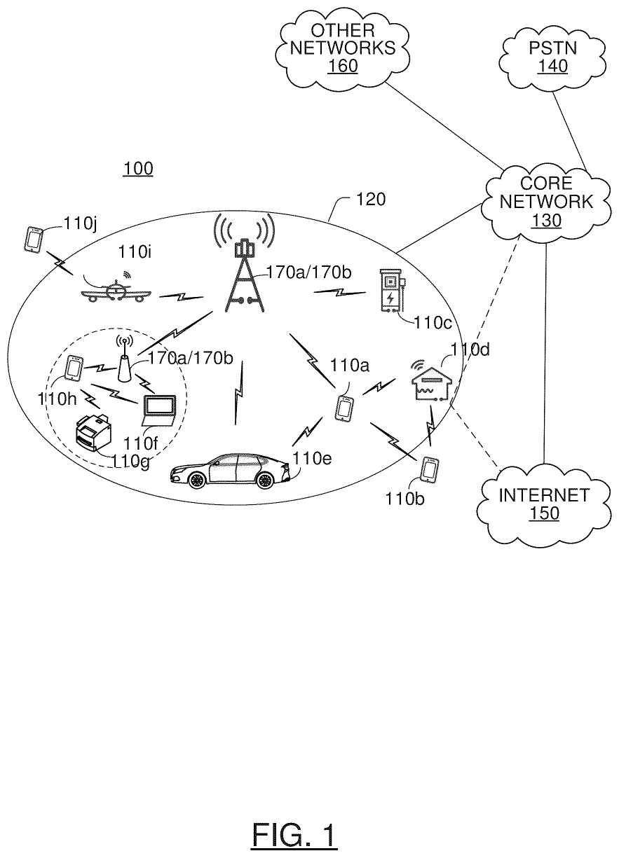

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

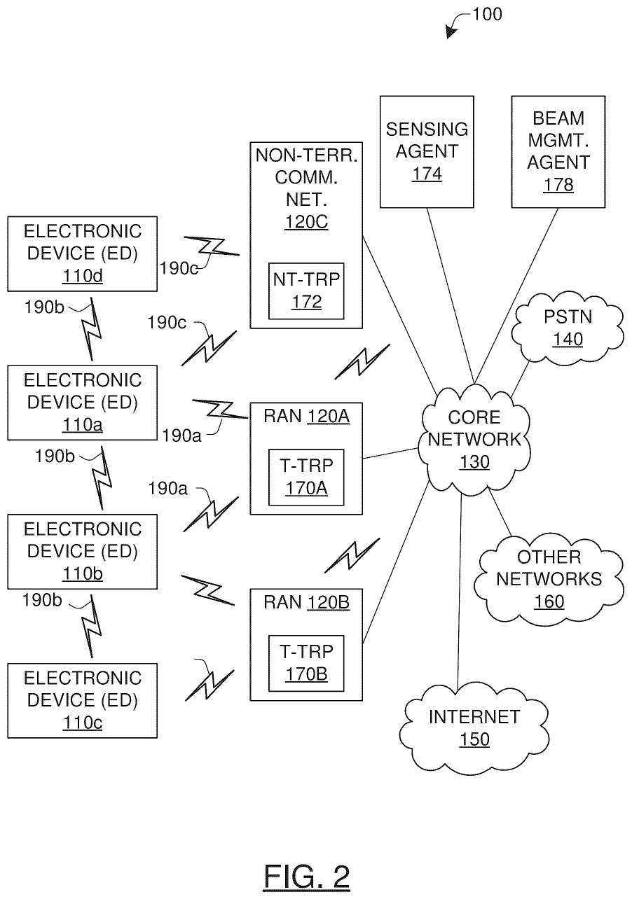

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and nod may also communicate directly with one another via one or more sidelink air interfaces 190b. In some examples, the ED nod may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such. Each RAN 120 may correspond to one or more serving cells (or simply “cells”). Herein, a serving cell is a combination of downlink resources and, optionally, uplink resources. The serving cell resources can correspond to one downlink (DL) carrier frequency and, optionally, one uplink (UL) carrier frequency, in case of a single-carrier serving cell or multiple DL carrier frequencies and, optionally, multiple UL carrier frequencies, in case of a multi-carrier serving cell. A linking between the carrier frequency of the downlink resources and the carrier frequency of the uplink resources may be indicated in system information transmitted on the downlink resources. A serving cell may also be defined as a radio network object that may be uniquely identified, by a UE no, from a cell identification, that is, a physical cell identifier (ID). Cell identification may be broadcast, say, via a synchronization signal and a physical broadcast channel (PBCH) block (SSB), over a geographical area from one or more TRPs 170. A cell may operate either in a frequency division duplex (FDD) mode or in a time division duplex (TDD) mode.

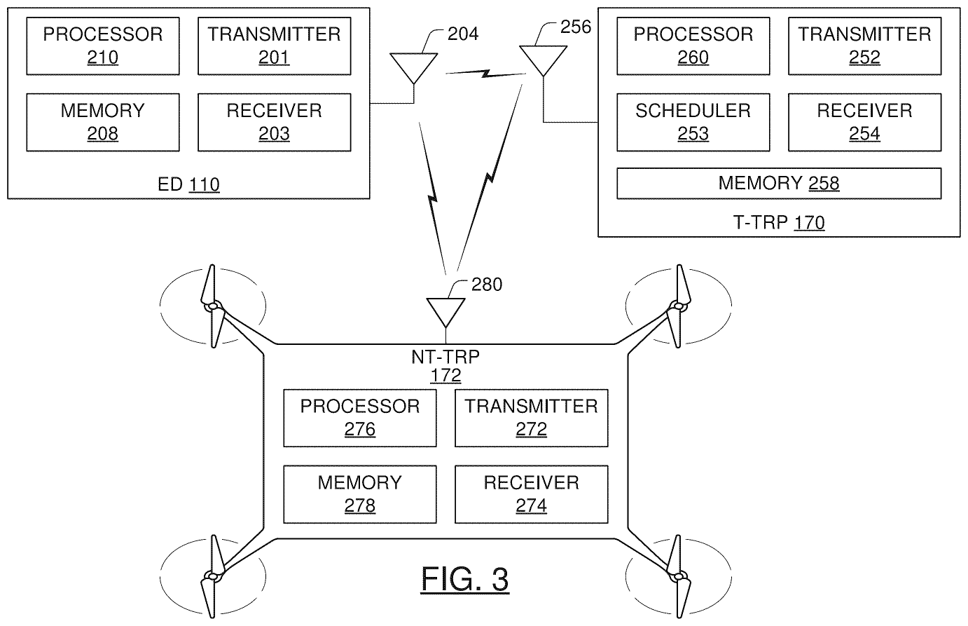

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b are each T-TRPs and will, hereafter, be referred to as T-TRP 170. Also shown in FIG. 3, an NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs) also known as synchronization signal and physical broadcast channel (PBCH) blocks, generating the system information, etc. In some embodiments, the processor 260 also generates an indication of a beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

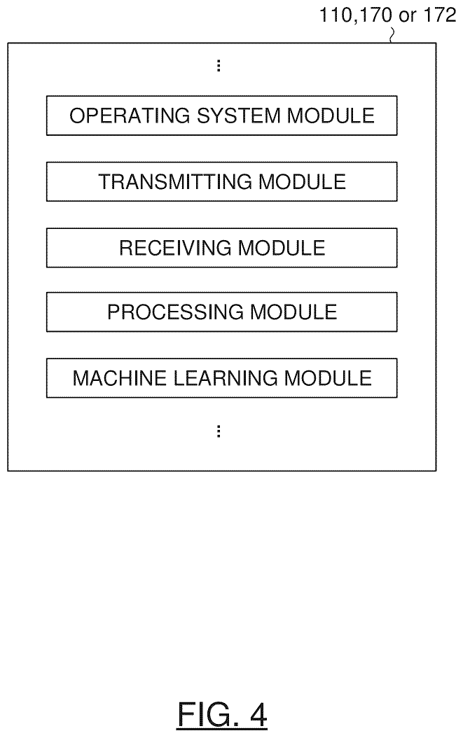

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occur on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 1 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, p/2, of the total mean transmitted power, for example, the value of β/2 is taken as 0-5%.

The carrier, the BWP or the occupied bandwidth may be signaled by a network device (e.g., by a base station 170) dynamically, e.g., in physical layer control signaling such as the known downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

FIG. 2 includes a beam management agent 178 (also called beam management entity). Unlike the EDs 110 and BSs 170, the beam management agent 178 does not transmit or receive communication signals. However, the beam management agent 178 may communicate configuration information within the communication system 100. The beam management agent 178 may be in communication with the core network 130 to communicate information with the rest of the communication system 100. By way of example, the beam management agent 178 may, in accordance with aspects of the present application, receive a feedback report from the ED 110a, determine, based on the feedback report, beam transition cycles and transmit beam transition cycle configuration information to the NT-TRPs 172 via the core network 130. Although only one beam management agent 178 is shown in FIG. 2, any number of beam management agents may be implemented in the communication system 100. In some embodiments, one or more beam management agents may be implemented at one or more non-terrestrial radio access communication networks 120C. The beam management agent 178 may be implemented as a physically independent entity located at the core network 130 with connection to multiple NT-TRPs 172. In other aspects of the present application, the beam management agent 178 may be implemented as a logical entity co-located inside an NT-TRP 172 through logic carried out by the processor 276. In other aspects of the present application, the beam management agent 178 may be implemented as a logical entity co-located inside a T-TRP 170 or a gNB.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and/or receiving sensing signals. Some sensing nodes are communication equipment that perform both communications and sensing. However, it is possible that some sensing nodes do not perform communications and are, instead, dedicated to sensing. A sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

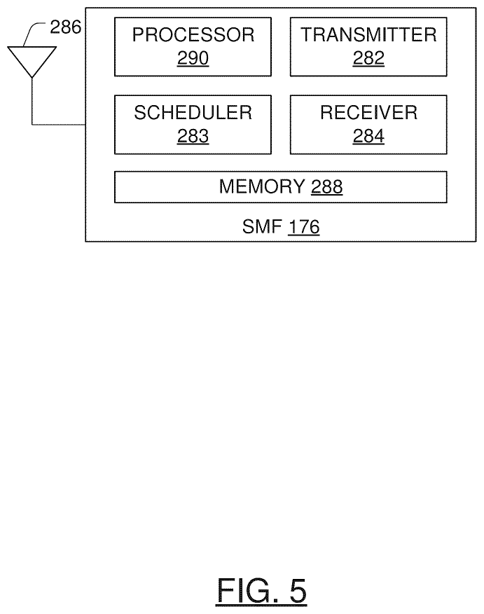

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in a process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a radio access technology (RAT) is used for sensing and same RAT is used for communication. This avoids the need to multiplex two different RATs under one carrier spectrum, or necessitating two different carrier spectrums for two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing respectively.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chrip 1} - {f}_{chrip 0}}{{t}_{chrip 1} - {t}_{chrip 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced, and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

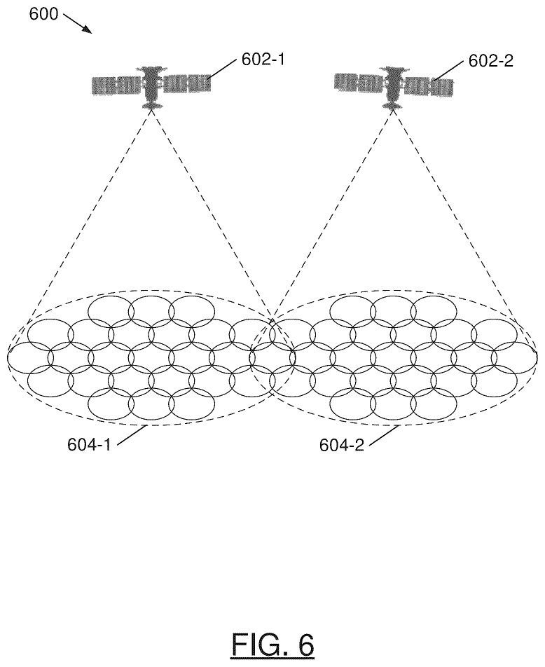

Conventional LEO satellite constellations comprise a plurality of satellites distributed across a small number of orbits to provide coverage all over the globe. In deployments of relatively small constellations, each satellite has a rather large satellite coverage area, with each satellite coverage area typically only partially overlapping with one or more other satellite coverage areas. In such deployments, a given user on the surface of the globe may have a so-called Line of Sight (LoS) towards, at most, a few (e.g., 1-3) satellites while looking into elevation angles greater than a minimum threshold, e.g., elevation angles greater than a 10° minimum threshold. Each given satellite may be shown to deploy beams to provide coverage for a target coverage area underneath the given satellite, with an elevation angle spanning a certain range, e.g., the range may include elevation angles greater than 30° as shown in an example conventional deployment 600, illustrated in FIG. 6. In the conventional deployment 600, illustrated in FIG. 6, a first satellite 602-1 has a first target coverage area 604-1 and a second satellite 602-2 has a second target coverage area 604-2.

As discussed hereinbefore, earth-fixed beam deployment is a name for a known method of deploying beams for use by non-geo-stationary satellites. Taking the case of satellites with earth-fixed beam deployment as an example, the elevation angle for a beam over a given target coverage area may be shown to span a certain range of elevation angles while the satellites are moving in their respective orbits. That is, starting first from the lower range of angles, θBₘᵢₙ, e.g., θₘᵢₙ=30°, the elevation angle for a given beam may be increased up to 90° and then decreased down to the minimum elevation angle, θₘᵢₙ. At the point at which the elevation angle for the given beam has been decreased down to the minimum elevation angle, the given beam may not be comfortably maintained by the same satellite anymore. At this point, the given beam may be switched to an adjacent satellite, thereby replacing the currently serving satellite as the satellite responsible for the maintenance of the given beam.

New LEO satellite constellation systems, which are sometimes known as “mega constellations,” are known to deploy thousands of satellites. A given user of one of these new systems may be shown to have a LoS towards tens of satellites, e.g., 20 to 60, while looking into a limited range of elevation angles (e.g., ≥53°). See Del Portillo, et al. “A technical comparison of three low earth orbit satellite constellation systems to provide global broadband” Acta astronautica 159 (2019): 123-135 for a visual representation of numerical results reported for the Starlink™ constellation deployed by SpaceX™. The visual representation compares the Starlink™ constellation to some smaller, conventional constellations. In relatively large constellations, it may be shown that each satellite provides coverage over a target coverage area underneath of it, in the same manner as the satellites in relatively small constellations. Notably, however, the target coverage area for satellites in relatively large constellations may be expected to be smaller than the target coverage area for satellites in relatively small constellations. Furthermore, satellites in relatively large constellations may have a LoS towards users farther out of their respective target coverage areas.

In the existing beam configuration schemes for satellite networks, it may be shown that only one satellite deploys a beam for each point in a given target coverage area, except for points in a transition region between two satellites. It follows that diversity enhancements and spectral efficiency enhancements are not exploited in the beam configuration schemes used in the mega constellations. Notably, a user may experience a connection failure in a condition wherein a satellite beam is blocked over a certain range of elevation angles, which condition may occur as the satellite moves in its orbit.

It is known that beam deployment in existing LEO satellite networks may be shown to follow a beam transition cycle. A particular beam transition cycle may be pre-configured and fixed for each target coverage area. The serving beam for a target coverage area may be shown to span a specific range of elevation angles. At a point in time at which a given LEO satellite is no longer able to provide the serving beam within the specific range of elevation angles, the task of providing the serving beam may be switched from the given LEO satellite to a next LEO satellite in the same orbit. This switching may repeat with a particular period. It may be said that the beam transition cycle is carried out with the period.

It may be readily understood that, while a given LEO satellite is moving in its orbit, a user will experience a serving beam that has an elevation angle that is constantly changing. It follows that there may be particular ranges of elevation angles or directions over the course of which the serving beam may be blocked, may fade and/or may fail.

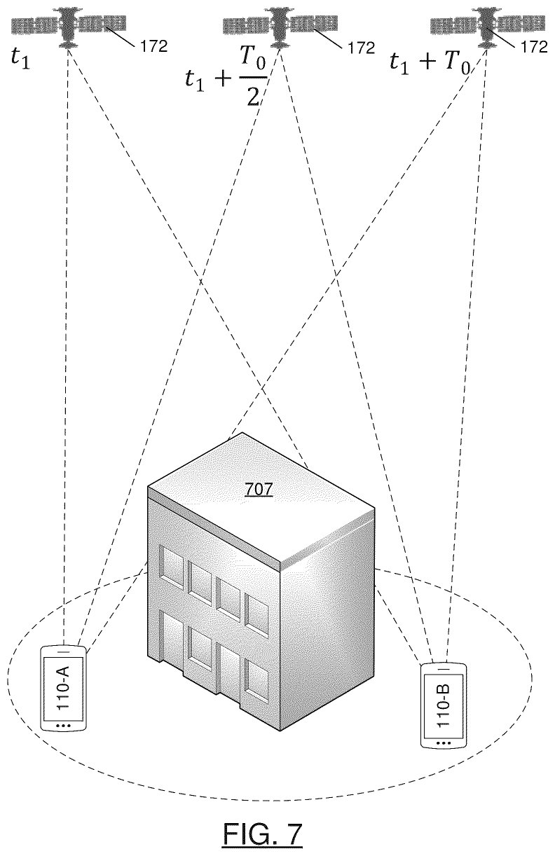

FIG. 7 illustrates a building 707, a first UE 110-A and a second UE 110-B. A serving beam for both UEs 110-A, 110-B is provided by an NT-TRP 172. The NT-TRP 172 is illustrated, in FIG. 7, at three distinct points in time: a first point in time, t₁; a second point in time,

$${t}_{1} + \frac{{T}_{0}}{2} ;$$

and a third point in time, t₁+T₀. At the first point in time, t₁, a beam from the NT-TRP 172 to the second UE 110-B is blocked by the building 707. The building 707 may be understood to represent a generic barrier preventing a LoS connection between the NT-TRP 172 and the second UE 110-B. Another example barrier is a mountain. At the second point in time,

$${t}_{1} + \frac{{T}_{0}}{2} ,$$

both UEs 110-A, 110-B have a LoS connection with the NT-TRP 172. At the third point in time, t₁+T₀, a beam from the NT-TRP 172 to the first UE 110-A is blocked by the building 707.

In addition to blocking, fading and failing due to barriers, other impediments to robust signal reception may be identified. For example, a signal from an NT-TRP 172 may be interfered with by signals from other nodes. The other nodes may be T-TRPs 170 or NT-TRPs 172. The interference may only occur over a limited set of directions. That is, a UE may be exposed to a strong source of interference over certain parts of a beam transition cycle.

Furthermore, the beam, which may be said to traverse a satellite channel, may undergo changes caused by various atmospheric conditions over different elevation angles. Yet another issue is that the beam may cover a distance that is out of a range covered by an antenna panel in use at the UE for a given beam transition cycle. The range covered by the antenna panel may be dependent upon on a type of the antenna panel and a heading of the UE.

In view of the UE-specific complexities described hereinbefore, communication connections between UE and satellite may be shown to fail due to being blocked or otherwise faded, while the satellite is moving. Responsive to a beam/connection failure, the UE may execute a beam failure recovery operation and/or a cell switching operation. These operations may be executed according to well-established NR connection reestablishment procedures. Switching from a serving beam provided by a first satellite to a serving beam provided by a second satellite according to reactive and measurement-based NR connection reestablishment procedures may be shown to be relatively slow, in that the UE may not be able to re-establish a connection in a timely fashion, due to significant propagation delay associated with a signal path from satellite to UE.

In overview, aspects of the present application relate to a UE-centric approach to exploiting a beam diversity that is understood to be provided as a consequence of having a plurality of satellites or other non-terrestrial nodes (of the same orbit or different orbits) within a line-of-sight of the UE in a LEO satellite mega constellation. Aspects of the present application may be shown to maintain a robust UE-satellite connection and enhance spectral efficiency, while maintaining a low complexity and signaling overhead. Aspects of the present application may be shown to exploit knowledge of satellite constellation and the periodicity of changes to the beam direction.

In a mega constellation of LEO satellites, deployment, by a plurality of satellites, of overlapping beams for a given target coverage area may be referenced as “satellite diversity.” Aspects of the present application relate to exploiting the satellite diversity to maintain a robust UE-satellite connection by implementing a “UE-centric beam transition cycle (BTC).” The UE-centric BTC may be contrasted with a known beam transition cycle used in the conventional satellite networks. The known beam transition cycle may be said to be specific to a target coverage area. Particularly, it may be understood that a given UE has certain constraints on beam direction. These constraints may depend, at least in part, on the UE position, the UE heading and the environment surrounding the UE. The environment may include nearby barriers, channel conditions and sources of interference sources, etc. The constraints may depend, at least in part, on UE-specific capabilities, such as a type of antenna panel in use at the UE. Moreover, aspects of the present application relate to a UE being able to spatially filter available beams such that only a subset of beams is considered. The filtering may, for example, depend on an elevation angle of satellites in orbit at each point and on UE-specific capabilities. Aspects of the present application relate to the UE transmitting a feedback report, to the satellite, where the feedback report includes indications of constraints and/or UE capabilities. The indications received in the feedback report may be used, by the satellite, to generate a UE-centric configuration of a beam transition cycle. The UE-centric BTC configuration may be shown to optimize spectral efficiency while enhancing connection robustness. One or more NT-TRPs 172 may then communicate, over at least one of physical signals and physical channels, with the UE 110, based on the UE-centric BTC configuration. The term “physical signals” may be understood to refer to reference signals, such as a demodulation reference signal (DMRS) (UL or DL), a channel state information reference signal (CSI-RS) in the downlink direction, a sounding reference signal (SRS) in the uplink direction, etc.

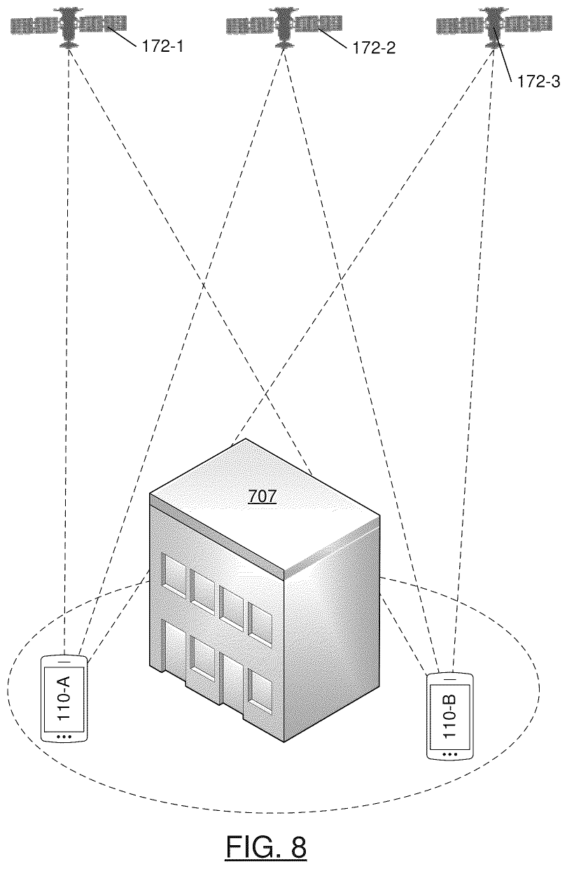

FIG. 8 illustrates a scenario including a first NT-TRP 172-1, a second NT-TRP 172-2 and a third NT-TRP 172-3 (collectively or individually 172). The NT-TRPs 172 may be understood to be part of a LEO mega constellation. The NT-TRPs 172 may be arranged to serve the first UE 110-A and the second UE 110-B, which are in the presence of the building 707 familiar from FIG. 7.

With the fixed, common BTC, which is known to be used in conventional satellite networks for a target coverage area, a serving beam may be blocked for an individual UE (such as the UE 110-A or the second UE 110-B) over certain parts of the duration of the common BTC period. For example, the first UE 110-A may be expected to experience a beam failure over the second half of the common BTC. To maintain a robust connection, aspects of the present application relate to switching the first UE 110-A to be served by a beam that is deployed by an adjacent NT-TRP 172 of the same orbit or a different orbit. This approach operates best when the adjacent NT-TRP 172 is located within a desired range of elevation angles from the perspective of the first UE 110-A.

Aspects of the present application may be shown to be applicable to wireless communications with LEO satellites (NT-TRPs) in an integrated terrestrial and non-terrestrial network. The satellites (NT-TRPs) may be organized into a plurality of orbits, wherein the orbits could adopt the same or different orbital configurations. Example orbital configurations include orbital tilt angle, number of satellites, etc. It should be clear that the UEs may be implemented as stationary terminals or as mobile user equipments. Aspects of the present application may be shown to facilitate beam tracking at the UE side and to facilitate switching between different satellites, while respecting UE-specific constraints or preferences.

Aspects of the present application may be shown to be applicable to beam switching and tracking functionalities in the RAN of integrated terrestrial and satellite (non-terrestrial) networks. Aspects of the present application may be implemented by collecting, at the NT-TRPs, feedback reports from the UEs. The feedback reports may be related to constraints on beam direction and UE-specific capabilities. The certain configurations may then be broadcast, where the configurations are related to the satellite constellation and basic beam transition parameters. The configurations may be shown to configure the UEs with specific beam transition cycles. Such signaling and feedback reports may be shown to distinguish aspects of the present application from the current state of the art.

Aspects of the present application relate to a method to implement a UE-centric BTC, which exploits a periodic pattern of beam transitions in a LEO satellite constellation.

Since the NT-TRPs are expected to move in an orbital fashion, the beams originating at the NT-TRPs are expected to follow a periodic pattern. A minimum period, T₀, may be determined, for the periodic pattern of beam transitions, based on constellation parameters for each orbit. It may be shown that the minimum period, T₀, for a given periodic pattern is representative of a duration, a “beam transition period,” taken for a given NT-TRP to reach a position that its next leading NT-TRP had reached at the beginning of the duration. It is worth noting that a periodic pattern may be observed both for earth-fixed beam deployments and for earth-moving beam deployments. For the purposes of the present application, attention is limited to the case of earth-fixed beam deployments. Accordingly, there is a focus on a target coverage area (i.e., the footprint of one beam) for ease of presentation.

As discussed hereinbefore, beam information may include an SSB resource identifier, which may also be referenced as an SSB index. In other instances, beam information may, additionally or alternatively, include a physical cell identity (PCI). Either of these values, and others, may be generically referenced as a “serving beam index.” There may be a periodic pattern of serving beam indices, which periodic pattern may have a serving beam index period, T=NT₀. The serving beam index period may be shown to include a quantity parameter, N, of beam transition periods (where N≥Nₘᵢₙ). The quantity parameter, N, of beam transition periods may also be called a number, N, of beam indices. Establishing the number of beam indices, N, to be greater than a minimum number of beam indices, Nₘᵢₙ, may be shown to allow for overlapping beams to be distinguished from each other at a receiver. A maximum transition time, Δₙ, (Δₙ≥T₀), may be used to denote a time for a beam from an n^{th} NT-TRP to sweep through a complete range of elevation angles, i.e., from a minimum elevation angle,

$${θ}_{n}^{min} ,$$

up to 90° and then from 90° down to the minimum elevation angle,

$${θ}_{n}^{min} .$$

The minimum number of beam indices, Nₘᵢₙ, may be determined as a function,

$${N}_{min} = ⌈ \frac{{Δ}_{n}}{{T}_{0}} ⌉ ,$$

of the minimum period, T₀, and the maximum transition time, Δₙ.

A beam transition function, δ_{b} (t), may be defined to provide a beam direction, at a given time, t, for a given beam with a beam center, P₀, and associated with a beam index, b. A successor beam transition function, δ_{b+1}(t), may also be defined. The successor beam transition function, δ_{b+1}(t), may be understood to provide a beam direction for a beam that is a successor to the given beam. The successor beam may be associated with a beam index, b+1. The successor beam transition function, δ_{b+1}(t), may be expected to be related to the given beam transition function, δ_{b}(t), according to an expression, δ_{b+1}(t)=δ_{b}(t−T₀). A basic beam transition function, δₙ(τ), τ∈[0, Δₙ), may be defined, for a maximum beam transition time interval, [0, Δₙ), to specify direction variations for a UE to use for a beam associated with communicating with an n^{th} NT-TRP. The n^{th} NT-TRP may be associated with a minimum elevation angle,

$${θ}_{n}^{min} .$$

A beam transition function, δ_{b} (t), for a beam with a particular beam index, b, may be described in terms of basic beam transition function, δₙ(τ), as follows,

$${δ}_{b} ( t ) = {\sum }_{m} {δ}_{n} ( t - {τ}_{0} - {bT}_{0} - {mNT}_{0} )$$

where τ₀ represents a constant shift corresponding to the beam center, P₀. It follows that a set, [symbol] ₙ(t), of beam transition functions at a time, t, may be expressed as [symbol] ₙ(t)={δ_{b}(t), b∈ [symbol] ₙ}, where [symbol] ₙ={0,1, . . . , N−1} represents a set of beam, indices of beam appropriate for communicating with NT-TRPs in the n^{th} orbit, where the beams are known to overlap.

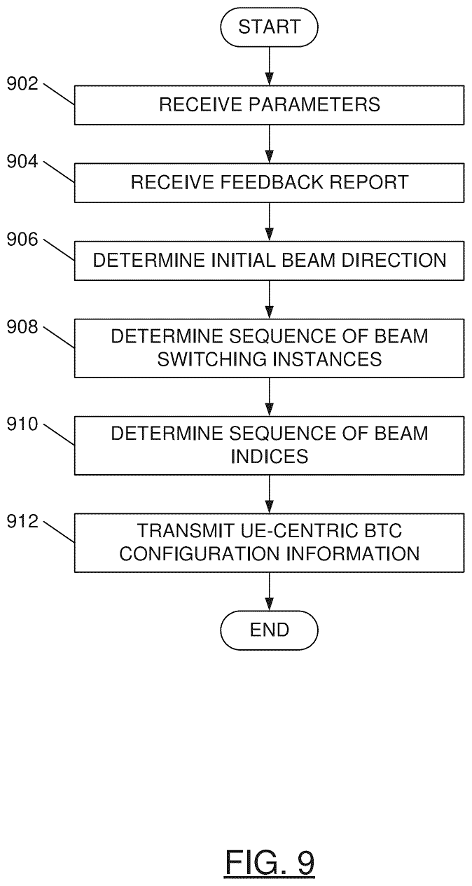

Aspects of the present application relate to a method, example steps of which method are illustrated in FIG. 9, for generating beam transition cycle (BTC) configuration information for a particular UE 110; that is, UE-centric BTC configuration information for the particular UE 110. The beam management agent 178 (see FIG. 2) may generate the UE-centric BTC configuration information on the basis of a basic beam transition function, δₙ(τ). The beam management agent 178 may, initially, receive (step 902) a set of parameters on the basis of which the UE-centric BTC configuration information may be determined. The set of parameters received (step 902) by the beam management agent 178 may, for example, include parameters that identify an n^{th} orbit with a maximum transition time, Δₙ, and a minimum transition period, T₀. The beam management agent 178 may also receive (step 904) a feedback report from the particular UE 110. The feedback report may include indications of constraints and/or capabilities specific to the particular UE 110. On the basis of the parameters and the feedback report, the beam management agent 178 may determine (step 906) an initial beam direction for the particular UE 110. The initial beam direction may correspond to a time offset, T₀, defined with respect to the basic beam transition function, δₙ(τ). The basic beam transition function, δₙ(τ), may be understood to begin at a minimum elevation angle,

$${θ}_{n}^{min} .$$

The beam management agent 178 may then determine (step 908) a sequence of beam switching instants over a time period, [t₀, t₀+mT₀). The time period, [t₀, t₀+mT₀), may be defined on the basis of a parameter, m, where m∈

$$[ 1 , \frac{{Δ}_{n}}{{T}_{0}} ⌋ ] .$$

The beam management agent 178 may then determine (step 910) a sequence of beam indices between which indices the particular UE 110 may switch. The switching may be understood to be expected to occur across periodic time intervals. The beam management agent 178 may then transmit (step 912), to the particular UE 110, configuration information, where the configuration information includes the UE-centric BTC configuration information for the particular UE 110. The UE-centric BTC configuration information may be understood to include indications of the sequence of beam switching instants and the sequence of beam indices between which indices the particular UE 110 may switch. Notably, the beam management agent 178 may be associated with a single serving cell or a plurality of serving cells. As discussed hereinbefore, one or more serving cells may correspond to one or more RANs 120 (see FIG. 2).

In a first example, upon receiving (step 902) a set of parameters and/or receiving (step 904) a UE-specific feedback report, the beam management agent 178 may configure UE-centric BTC configuration information that specifies use of a single beam in each period. The beam management agent 178 may first determine (step 906), for the particular UE 110, an initial beam direction for a beam associated with a specific beam index, b. As discussed hereinbefore, the initial beam direction may correspond to a time offset, τ₀, that is defined with respect to a basic beam transition function, δₙ(τ). The parameters received in step 902 may include an indication of a selected time period, i.e., [t₀, t₀+mT₀) and a rule to allow the particular UE 110 to determine a next beam index. An example rule to allow the particular UE 110 to determine a next beam index may be expressed as b←b+I (mod N), where a so-called “beam index shift,” I, is representative of a value that is to be configured by the beam management agent 178.

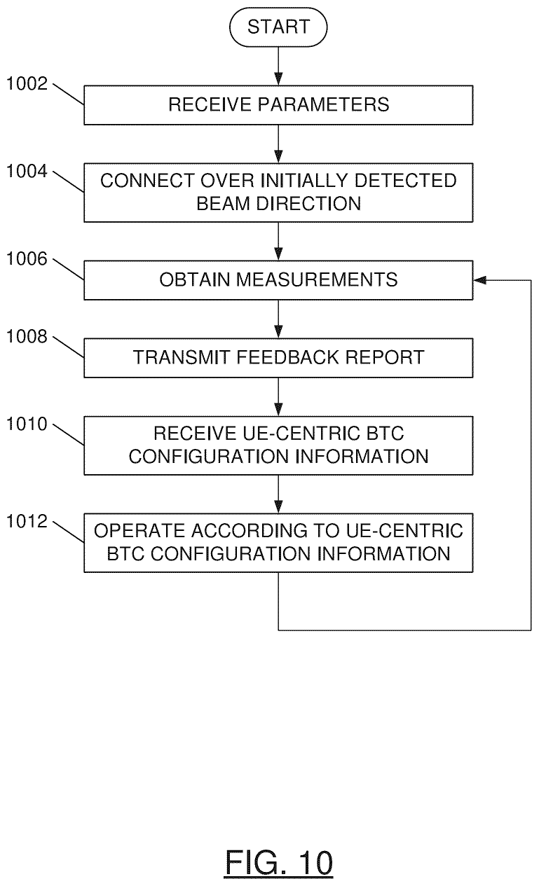

FIG. 10 illustrates example steps in a method, carried out at a UE, for implementing UE-centric BTC configuration information. The UE may initially receive (step 1002) a set of parameters on the basis of which the UE would operate in the absence of UE-centric BTC configuration information. The UE may connect (step 1004) to an NT-TRP over an initial beam direction. The UE may obtain (step 1006) measurements and, on the basis of the measurements, the UE may determine constraints and/or capabilities specific to the UE. Using the connection to the NT-TRP, the UE may transmit (step 1008) a feedback report. The feedback report may include a measurement report (including measurements obtained in step 1006), indications of the constraints and/or capabilities specific to the UE. The UE may then receive (step 1010) the UE-centric BTC configuration information that was transmitted by the beam management agent 178 in step 912 (see FIG. 9). Responsive to receiving the UE-centric BTC configuration information, the UE may operate (step 1012) according to the UE-centric BTC configuration information. That is, the UE may communicate (step 1012) channels and data signals, with one or more NT-TRPs, based on the BTC configuration information.

It may be understood that, from the UE point of view, the beam management agent 178 may be a radio access network node such as an NT-TRP 172, a T-TRP 170 or may be a node in the core network 130. Thus, the steps 1002, 1008, 1010 could be understood as between the UE and the radio access network node 120 or the core network 130.

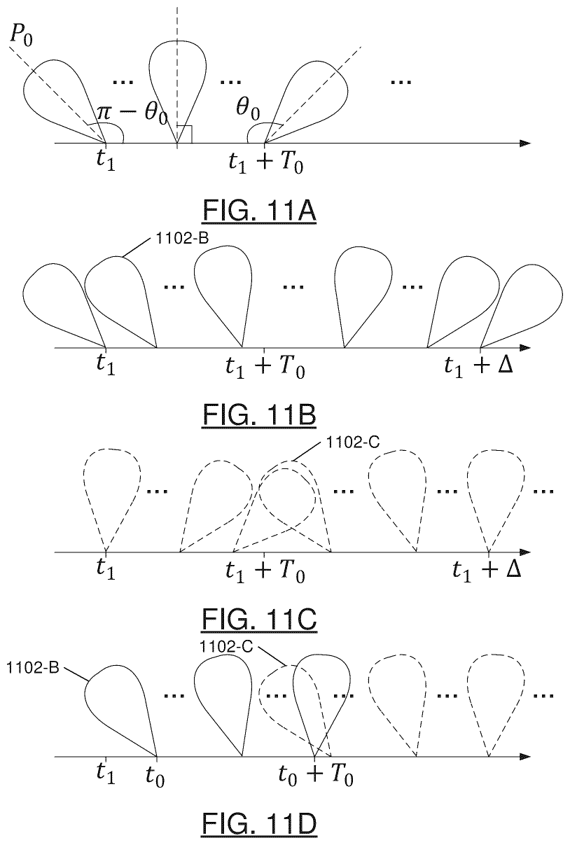

FIG. 11A illustrates a first example of a UE (not shown) operating to adjust beam directions in accordance with a conventional BTC. At a first time, t₁, the UE uses a first beam direction, π−θ₀, when communicating with an NT-TRP (not shown). As the NT-TRP moves on its orbit, the UE adjusts its beam direction. At the middle of a period of a particular duration, T₀, that is, at a second time,

$${t}_{1} + \frac{{T}_{0}}{2} ,$$

FIG. 11A illustrates that the UE is using a second beam direction,

$$\frac{π}{2} .$$

At the end of the period, that is, at a third time, t₁+T₀, the UE is seen to be using a third beam direction, θ₀.

FIG. 11B illustrates a second example of a UE (not shown) operating to adjust beam directions in accordance with a conventional BTC. At a first time, t₁, the UE uses a first beam direction when communicating with a first NT-TRP (not shown). The UE uses a beam with beam index 0 to communicate with the first NT-TRP. The beam with beam index 0 is associated, in FIG. 11B, with a reference numeral 1102-B. As the first NT-TRP moves on its orbit, the UE adjusts the direction of the beam 1102-B with beam index 0.

FIG. 1C illustrates a third example of a UE (not shown) operating to adjust beam directions in accordance with a conventional BTC. At a first time, t₁, the UE uses a second beam direction when communicating with a second NT-TRP (not shown). The UE uses a beam with beam index 1 to communicate with the second NT-TRP. The beam with beam index 1 is associated, in FIG. 11C, with a reference numeral 1102-C. As the second NT-TRP moves on its orbit, the UE adjusts the direction of the beam 1102-C with beam index 1. At a point in time, the direction of the beam 1102-C with beam index 1 may not be adjusted any further for communication with the second NT-TRP. That is, it is expected that, after many adjustments, the direction of the beam 1102-C with beam index 1 reaches a minimum elevation angle for communication with the second NT-TRP. At this point, the UE adjusts the direction of the beam 1102-C with beam index 1 for communication with a third NT-TRP (not shown).

For the example of conventional BTCs in FIG. 11B and FIG. 11C, the duration of a conventional BTC time interval may not necessarily cover the whole duration of Δ (indeed Δ may comprise multiple T₀, that is why there are multiple NT-TRPs that can provide coverage over the same target coverage area while respecting the minimum elevation angle). For example, if Δ=3T₀ and the BTC comprises the whole duration of Δ, at the end of the interval, where the UE should switch to a next NT-TRP in the same orbit, the UE may be configured to skip two NT-TRPs and switch to the third NT-TRP coming in the orbit.

FIG. 11D illustrates an example of a UE (not shown) operating to adjust beam directions in accordance with a received UE-centric BTC configuration information, where the selected time period is [t₀, t₀+T₀), i.e., m=1, N=2.

The UE initially communicates with the first NT-TRP using the beam 1102-B with beam index 0 and with an initial beam direction corresponding to a time offset, t₀−t₁.

At the end of each time period, [t₀, t₀+T₀), the beam index is shifted by a beam index shift, I=1, and the UE commences communicating with an NT-TRP distinct from the first NT-TRP using the beam 1102-C with beam index 1. As discussed hereinbefore, generically, the beam direction for beam with beam index b+1 at the end, to +T₀, of a time period, [t₀, t₀+T₀), will be the same as the beam direction for the beam with the beam index b at the beginning, t₀, of the time period, [t₀, t₀+T₀). Accordingly, and as illustrated in FIG. 11D, the initial beam direction the beam 1102-C with beam index 1 corresponds to the initial beam direction of the beam 1102-B with beam index 0.

The beam management agent 178 may transmit (step 912, see FIG. 9), to a UE, UE-centric BTC configuration information that specifies two or more beams of the same orbit. This may be accomplished by specifying a set of distinct beam indices, b₁, b₂, . . . , b_{z}, and a set of time instances, t₀, t₁, . . . , t_{z}, to switch between the beams having the distinct beam indices across one period, [t₀, t_{z}), where t_{z}=t₀+mT₀. The UE-centric BTC configuration information transmitted (step 912) by the beam management agent 178 may also include a rule to allow the UE to determine a next beam index. An example rule may be expressed as bⱼ−bⱼ+I mod N. A UE-centric BTC configuration information that specifies two or more beams of different orbits may be similarly accomplished by specifying a subset of beam indices of certain orbits. At specified time instances across one time period, the UE may switch to a beam with a beam index in a specified subset of beam indices.

Received (step 1010, FIG. 10) UE-centric BTC configuration information may be used, by the UE, to track a receive beam direction and to switch between different NT-TRPs of the same orbit or of different orbits. Aspects of the present application may be shown to reduce overhead of beam measurements and the associated signaling. In known beam switching schemes, beam measurements and the associated signaling may be shown to be repeated for every beam switching instant. Aspects of the present application may be shown to reduce overhead by exploiting the periodic pattern of beam transition, while reducing likelihood of a beam failure. For IoT devices, a discontinuous reception (DRX) window may be configured in accordance with UE-centric BTC configuration information. Accordingly, likelihood of successful transmission/reception may be shown to have been enhanced, while facilitating access for the UE by providing an estimate of the beam direction based on the UE-centric BTC configuration information.

The preparation (steps 906, 908, 910 of FIG. 9) of a UE-centric configuration of the BTC may be shown to help the beam management agent 178 to adaptively activate/deactivate a different number of overlapping beams from NT-TRPs of the same orbit or of different orbits. The adaptive activation/deactivation of overlapping beams may be shown to depend on UE traffic demand at each point in a coverage area. The preparation of a UE-centric configuration of the BTC may also be shown to enable the beam management agent 178 to respect certain constraints on the beam direction. Respecting constraints on the beam direction may, for example, involve respecting a maximum interference limit towards other nodes. Respecting constraints on the beam direction may, for example, involve respecting a maximum permissible Effective Isotropic Radiated Power (EIRP). Each UE-centric BTC may be configured in a way that maximizes spectral efficiency while respecting the UE constraints and preferences.

Some of the constraints on beam direction and spatial filtering of the signals depend on the UE position/heading and the surrounding environment. Accordingly, aspects of the present application benefit from the UE proactively sensing (step 1004, FIG. 10) the channel and transmitting (step 1008, FIG. 10) a feedback report to the beam management agent 178. For instance, the UE may detect a barrier in a nearby distance over a range of directions so that a LoS would potentially be blocked over the range of directions. The UE antenna panels may be understood to cover a certain range of elevation angles. However, the range of elevation angles covered may be shown to vary in dependence on the heading of the UE. Moreover, signals exchanged over a channel between a UE and an NT-BTC may be shown to experience various atmospheric conditions over various elevation angles. Accordingly, it may be shown that a specific UE may not be able to receive a strong signal over certain elevation angles.

Another example of a position dependent constraint is interference that is received, by a UE, due to signals from nodes that are local to the UE. The nodes that are local to the UE may include T-TRPs, HAPs, etc. Another example of a position dependent constraint is a limit (a maximum) on uplink transmission power. A maximum uplink transmission power may be shown to be put in place to limit interference towards certain directions. Another example of a position dependent constraint is a Maximum Permissible Exposure (MPE) over certain directions.

Aspects of the present application that are related to the UE being configured to proactively sense (step 1006) the channel and transmit (step 1008) a feedback report via an NT-TRP with which the UE has established (step 1004) a connection may be shown to facilitate respecting these sorts of constraints and, consequently, facilitate avoidance of beam failures. The UE feedback report may indicate a preferred range of directions by indicating a specific portion of a beam transition time period, Δₙ, over which the beam can be detected by the UE. Alternatively, the UE may explicitly signal the range of azimuth angles or elevation angles that are available to be used for communication.

Inter-beam interference that is observed by the UE may be shown to vary over different elevation angles. Depending on capabilities of the UE, each UE may be able to spatially filter a different subset of beams over each part of a beam transition time interval Δₙ. The UE may transmit (step 1008) a feedback report indicating one or more subsets, [symbol] ₙ, [symbol] ₙ⊆ [symbol] ₙ, of beams and the associated part of the beam transition time interval for which UE can mitigate/cancel inter-beam interference for every pair of beams in the subset, [symbol] ₙ, of beams.

Each UE may be shown to have certain capabilities that imply specific constraints on the beam direction or constraints on the spatial filtering of signals. For instance, capabilities such as the number of antenna panels, type of antenna panels and steering capability (electrical steering, mechanical steering, range of steering) may be shown to imply certain constraints on beam direction. Specific constraints may be pre-defined for certain capabilities. For example, a certain range of elevation angles (a constraint) may be pre-defined for each type of antenna panel (a capability). The capability called “type of antenna panel” may be arranged to correspond, e.g., to a certain capability group. It follows that the UE may simply signal an indication of a certain capability group by signaling an indication of a capability group index.

Capabilities such as minimum required angular separation and number of beams that can be detected may be shown to imply certain constraints on spatial filtering of the signals. As discussed hereinbefore, specific constraints may be pre-defined for certain capabilities. Accordingly, the capabilities that imply constraints on spatial filtering may be arranged to correspond, e.g., to a certain capability group. It follows that the UE may simply signal an indication of a certain capability group by signaling an indication of a capability group index.

In overview, aspects of the present application relate to a goal of addressing UE-specific beam direction constraints/preferences when configuring, at the beam management agent 178, a UE with a UE-centric BTC. Towards this goal, the UE may obtain (step 1004) measurements for signals from a given NT-TRP over different elevation angles, using certain configurations. In particular, the UE may be pre-configured (step 1002) with NT-TRP constellation information and parameters that describe basic beam transition patterns for the NT-TRPs. Such pre-configuration may be useful, e.g., in that the pre-configuration may allow the UE to express constraints/preferences in terms of the basic beam transition time interval. Such pre-configuration may also be useful, e.g., in that the pre-configuration may allow the UE to identify a subset of beams that may be spatially filtered by the UE. Subsequent to obtaining (step 1004) the measurements, the UE may transmit (step 1008) a feedback report including indications of the measurements, indications of UE capabilities as well as indications regarding constraints on beam directions. Upon receiving (step 904, FIG. 9) feedback from a plurality of UEs, the beam management agent 178 may configure a UE-centric BTC for each UE in the plurality of UEs and then transmit (step 912) UE-centric BTC configuration information to each UE. The BTC configuration information for different UEs may allow for spectral efficiency to be optimized (e.g., by minimizing the inter-beam interference) while respecting the various preferences/constraints associated with the plurality of UEs.

Notably, according to aspects of the present application, a given UE may repeat channel measurements (step 1006) from time to time and transmit (step 1008) additional feedback reports to the beam management agent 178, thereby allowing the beam management agent 178 to update (steps 906, 908 and 910) the UE-centric BTC configuration information. For instance, as a consequence of the UE being in motion, the UE may arrive at a new location at which the UE detects a new barrier. The new barrier may limit the range of elevation angles that may be employed for communications with an NT-TRP. The UE may transmit (step 1008) a feedback report that explicitly indicates a change to one of the constraints on the beam direction. Alternatively, the UE may request an adjustment to current UE-centric BTC configuration information, e.g., by suggesting a shift to a starting time for the BTC time period (i.e., t₀←t₀+Δt₀). Notably, given the long distance between the NT-TRP and the UE, it may be shown to take some time until the slow movements of the UE contribute to considerable changes with respect to the NT-TRP in a given orbit. It follows that the frequency of such adjustments to a UE-centric BTC may be expected to be relatively low (in the order of few/several minutes), so that the UE-centric BTC configuration information may be updated only in a semi-static fashion.

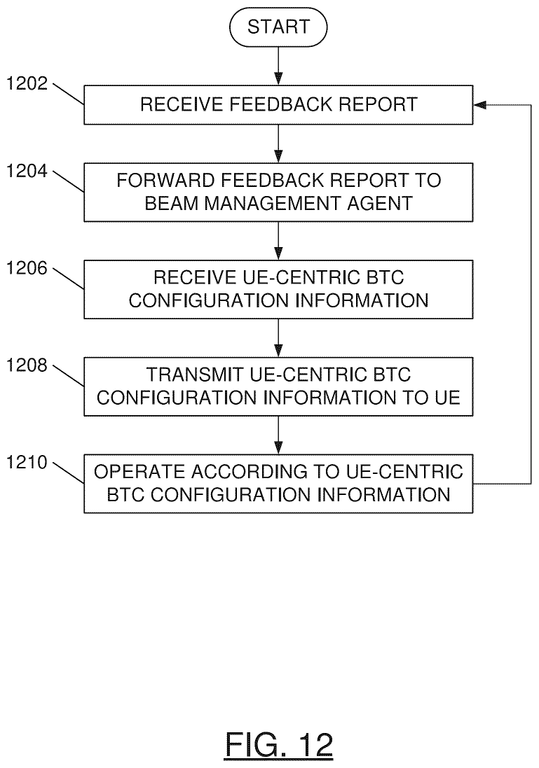

FIG. 12 illustrates example steps in a method of an NT-TRP 172 providing BTC configuration information to a UE 110. Initially, the NT-TRP 172 may receive (step 1202), from the UE 110, a feedback report. Upon recognizing that the feedback report is destined for the beam management agent 178, the NT-TRP 172 may forward (step 1204) the feedback report to the beam management agent 178. Indeed, if the beam management agent 178 is a logical part of the NT-TRP 172, the forwarding (step 1204) need not relate to sending the feedback report very far. Subsequently, the NT-TRP 172 may receive (step 1206) UE-centric BTC configuration information destined for the UE 110. The NT-TRP 172 may then transmit (step 1208) the BTC configuration information to the UE 110.

The NT-TRP 172 may transmit (step 1208) the UE-centric BTC configuration information to the UE 110 using RRC signaling that is specific to the UE 110. RRC signaling that is specific to the UE 110 may, for one example, include unicast dedicated/UE-specific RRC signaling. UE-specific signaling may, for another example, include signaling that is specific to a group of UEs of which the UE 110 is a part, that is, UE-group specific RRC signaling. UE-group specific signaling may include group-common multicast RRC signaling to all UEs in the group. Cell-specific RRC signaling may include common broadcast RRC signaling to all UEs in the cell. Cell-specific signaling may, for a further example, include broadcast RRC signaling using a master information block (MIB) or a system information block (SIB).

The NT-TRP 172 may then proceed to operate (step 1210) according to the BTC configuration information. That is, the NT-TRP 172 may communicate (step 1210) channels and/or data signals, with the UE 110, based on the BTC configuration information.

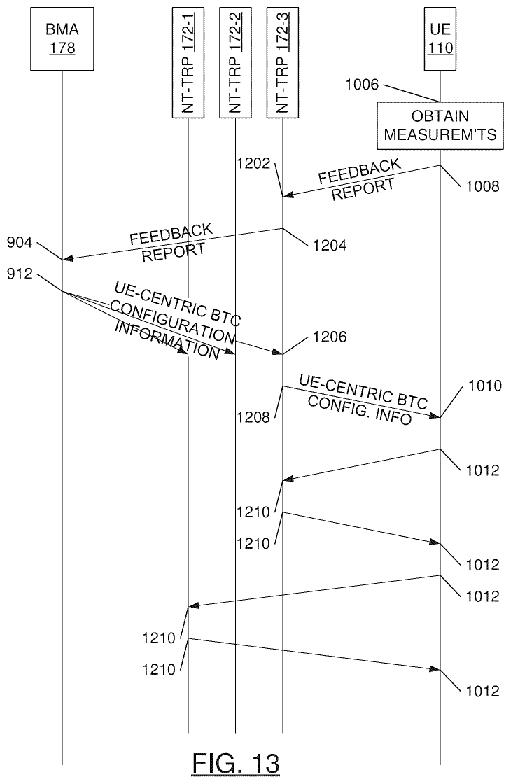

FIG. 13 illustrates a flow diagram that provides an overview of signal flow amongst a beam management agent 178, a first NT-TRP 172-1, a second NT-TRP 172-2, a third NT-TRP 172-3 and a UE 110. Before the signal flow begins, the UE 110 obtains (step 1006, FIG. 10) measurements of a channel between the UE 110 and the third NT-TRP 172-3. The UE 110 transmits (step 1008, FIG. 10) a feedback report that is subsequently received (step 1202, FIG. 12) by the third NT-TRP 172-3. The third NT-TRP 172-3 then forwards (step 1204, FIG. 12) the feedback report to the beam management agent 178. Upon receiving (step 904, FIG. 9) the feedback report, the beam management agent 178 may prepare (steps 906, 908, 910 of FIG. 9) UE-centric BTC configuration information. The beam management agent 178 may then transmit (step 912, FIG. 9) the UE-centric BTC configuration information toward the UE 110. More particularly, the beam management agent 178 may transmit (step 912, FIG. 9) the UE-centric BTC configuration information to the third NT-TRP 172-3. Upon receiving (step 1206, FIG. 12) the UE-centric BTC configuration information, the third NT-TRP 172-3 may forward (step 1208, FIG. 12) the UE-centric BTC configuration information to the UE 110. Upon receiving (step 1010, FIG. 10) the UE-centric BTC configuration information. The UE 110 may commence operating (step 1012) according to the UE-centric BTC configuration information. That is, the UE may communicate (step 1012) channels and data signals, with one or more NT-TRPs, based on the BTC configuration information. Responsively, the third NT-TRP 172-3 may commence operating (step 1210) according to the BTC configuration information. That is, the third NT-TRP 172 may communicate (step 1210) channels and data signals, with the UE 110, based on the BTC configuration information.

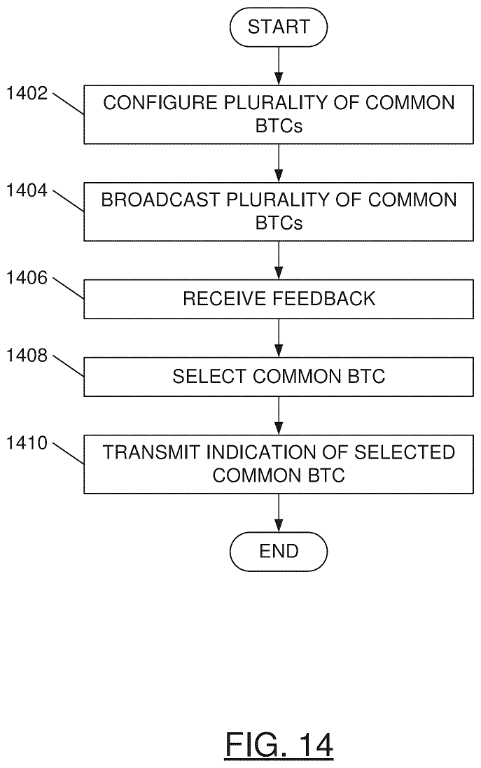

Aspects of the present application relate to an approach to implementing UE-centric BTCs, which approach involves defining a plurality of common BTCs. FIG. 14 illustrates example steps in a method of providing BTC configuration information to a UE.

The beam management agent 178 may then select, for a given UE, a given common BTC from among the plurality of common BTCs. In aid of the selection, the beam management agent 178 may determine that the given common BTC best meets preferences/constraints that are specific to the given UE.

Initially, the beam management agent 178 may configure (step 1402) a plurality of common BTCs. In particular, the beam management agent 178 may configure (step 1402) the common BTCs in view of historical data about traffic demand for UEs in a given target coverage area and in view of known constraints for UEs in the given target coverage area. The common BTCs, in this case, may also be configured (step 1402) in a way that maximizes an average spectral efficiency. The beam management agent 178 may then broadcast (step 1404) the configuration information for the plurality of BTCs to the UEs in the given target coverage area.

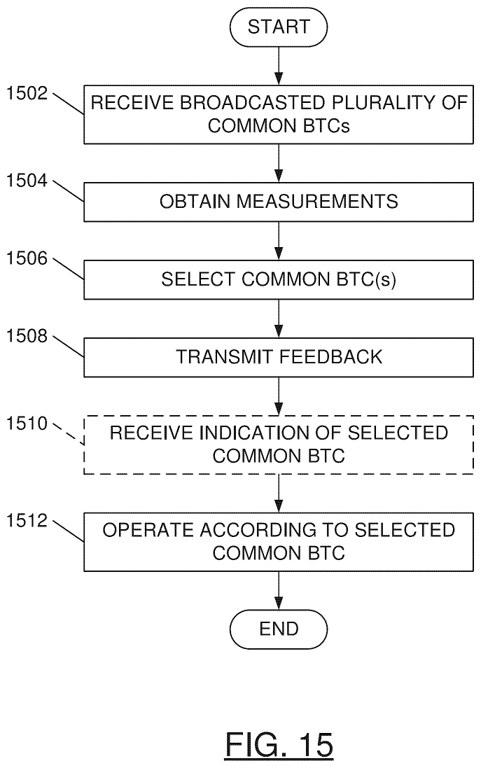

FIG. 15 illustrates example steps in a method, carried out at a UE, for implementing UE-centric BTC configuration information. Initially, the UE receives (step 1502) the configuration information for the plurality of BTCs, which configuration information was broadcast, by the beam management agent 178, in step 1404.

In view of the received configuration information for the plurality of common BTCs, the UE may obtain (step 1504) measurements of signal variations for each of the common BTCs over different elevation angles. The UE may then select (step 1506) the one of the common BTCs that optimally meets constraints/preferences that are specific to the UE. The UE may then transmit (step 1508) a feedback report to the beam management agent 178. The feedback report may include an indication of the selected common BTC. In a case wherein, for example, the configuration information for the plurality of common BTCs includes a distinct index associated with each common BTC among the plurality of common BTCs, the feedback report may include an indication of an index associated with the selected common BTC.

Alternatively, the UE may then select (step 1506) a plurality of common BTCs that each meet the constraints/preferences that are specific to the UE. In this alternative, the feedback report transmitted (step 1508), by the UE, may include a report that indicates a list of the plurality of common BTCs that have been selected.

Returning to FIG. 14, the beam management agent 178 receives (step 1406) the feedback report. The feedback report may include detailed measurement reports along with indications of UE-specific constraints and/or capability. In the case wherein the feedback report includes a report with a list, the beam management agent 178 may, responsive to receiving (step 1406) the feedback report, select (step 1408) one common BTC among the common BTCs in the list. The selecting (step 1408) may, for example, take into account feedback received (step 1406) from each UE among a plurality of UEs. The beam management agent 178 may then transmit (step 1410), to the UE, an indication of the selected common BTC.

The UE may subsequently receive (step 1510) the indication of the selected common BTC and proceed to operate (step 1512) according to the selected common BTC. Notably, the receipt (step 1510) of an indication of a common BTC selected from a list only applies in cases wherein the feedback report transmitted (step 1508), by the UE, includes a list.

Aspects of the present application are based, in part, on an assumption of an earth-fixed sort of beam deployment by the NT-TRPs. The UE-centric beam transition cycle configuration representative of aspects of the present application may, however, be shown to be applicable when NT-TRPs implement an earth-moving sort of beam deployment. In the case of the earth-moving sort of beam deployment, the UE conventionally switches between different beams of the same NT-TRP until the UE reaches an edge beam (with the minimum elevation angle). Upon reaching the edge beam, the UE switches to a beam of an adjacent NT-TRP. With a UE-centric approach representative of aspects of the present application, the UE may not need to switch to a beam from an adjacent satellite just at the point wherein the UE has reached the edge beam with the minimum elevation angle. Instead, the UE may switch to a beam from an adjacent satellite at a configured point based on UE-centric BTC configuration information that specifies a sequence for beam switching. Accordingly, the concept of UE-centric beam transition cycles and other related signaling may be shown to extensible to be employed in the context of networks with NT-TRPs that implement an earth-moving sort of beam deployment.

It should be appreciated that one or more steps of the embodiment methods provided herein may be performed by corresponding units or modules. For example, data may be transmitted by a transmitting unit or a transmitting module (or transmitter in detailed implementation). Data may be received by a receiving unit or a receiving module (or receiver in detailed implementation). Data may be processed by a processing unit or a processing module (or processor in detailed implementation). The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
transmitting, to a user equipment (UE), beam transition cycle (BTC) configuration information; and
communicating, from at least one non-terrestrial transmit-receive point (NT-TRP) with the UE, at least one of physical signals or physical channels based on the BTC configuration information.

2. The method of claim 1, further comprising:
receiving, from the UE, a feedback report, wherein the BTC configuration information is generated based on the feedback report, and wherein the feedback report indicates at least one of:
measurement information obtained at the UE for a communication channel with a given NT-TRP among the at least one NT-TRP,
a beam direction constraint, or
a capability of the UE.

3. The method of claim 1, wherein the BTC configuration information indicates at least one of:
an initial beam direction,
a sequence of beam switching instants, or
a sequence of beam indices corresponding to the sequence of beam switching instants.

4. The method of claim 1, further comprising:
receiving a parameter, wherein the parameter indicates at least one of:
an identification of an orbit of a given NT-TRP among the at least one NT-TRP,
maximum transition time for communication between the UE and the given NT-TRP, or
minimum transition period for communication between the UE and the given NT-TRP.

5. The method of claim 1, wherein the communicating with the UE comprises:
switching, at a switching time indicated in the BTC configuration information, from a first serving beam to a second serving beam according to the BTC configuration information.

6. A method comprising:
receiving, by a user equipment (UE), beam transition cycle (BTC) configuration information; and
communicating, by the UE with at least one non-terrestrial transmit-receive point (NT-TRP), at least one of physical signals or physical channels in accordance with the BTC configuration information.

7. The method of claim 6, further comprising:
transmitting, from the UE, a feedback report, wherein the feedback report indicates at least one of:
measurement information obtained at the UE for a communication channel with a given NT-TRP among the at least one NT-TRP,
a beam direction constraint, or
a capability of the UE.

8. The method of claim 7, wherein the BTC configuration information indicates at least one of:
an initial beam direction,
a sequence of beam switching instants, or
a sequence of beam indices corresponding to the sequence of beam switching instants.

9. The method of claim 6, further comprising:
receiving a parameter, wherein the parameter indicates at least one of:
an identification of an orbit of a given NT-TRP among the at least one NT-TRP,
maximum transition time for communication between the UE and the given NT-TRP, or
minimum transition period for communication between the UE and the given NT-TRP.

10. The method of claim 6, wherein the communicating with the at least one NT-TRP comprises:
switching, at a switching time indicated in the BTC configuration information, from a first serving beam to a second serving beam according to the BTC configuration information.

11. A communication apparatus comprising:
at least one processor coupled with a non-transitory computer readable storage medium storing instructions that, when the instructions executed by the at least one processor, cause the communication apparatus to perform operations comprising:
transmitting, to a user equipment (UE), beam transition cycle (BTC) configuration information; and
communicating, from at least one non-terrestrial transmit-receive point (NT-TRP) with the UE, at least one of physical signals or physical channels based on the BTC configuration information.

12. The communication apparatus of claim 11, wherein the BTC configuration information is carried in:
unicast dedicated/UE-specific radio resource control (RRC) signaling,
UE-group specific RRC signaling, or
common broadcast RRC signaling.

13. The communication apparatus of claim 11, the operations further comprising:
receiving, from the UE, a feedback report, wherein the BTC configuration information is generated based on the feedback report, and wherein the feedback report indicates at least one of:
measurement information obtained at the UE for a communication channel with a given NT-TRP among the at least one NT-TRP,
a beam direction constraint, or
a capability of the UE.

14. The communication apparatus of claim 11, wherein the BTC configuration information indicates at least one of:
an initial beam direction,
a sequence of beam switching instants, or
a sequence of beam indices corresponding to the sequence of beam switching instants.

15. The communication apparatus of claim 11, the operations further comprising:
receiving a parameter, wherein the parameter indicates at least one of:
an identification of an orbit of a given NT-TRP among the at least one NT-TRP,
maximum transition time for communication between the UE and the given NT-TRP, or
minimum transition period for communication between the UE and the given NT-TRP.

16. The communication apparatus of claim 11, wherein the communicating with the UE comprises:
switching, at a switching time indicated in the BTC configuration information, from a first serving beam to a second serving beam according to the BTC configuration information.

17. A communication apparatus comprising:
at least one processor coupled with a non-transitory computer readable storage medium storing instructions that, when the instructions executed by the at least one processor, cause the communication apparatus to implement operations comprising:
receiving beam transition cycle (BTC) configuration information; and
communicating, with at least one non-terrestrial transmit-receive point (NT-TRP), at least one of physical signals or physical channels in accordance with the BTC configuration information.

18. The communication apparatus of claim 17, the operations further comprising:
transmitting a feedback report, wherein the feedback report indicates at least one of:
measurement information for a communication channel with a given NT-TRP among the at least one NT-TRP,
a beam direction constraint, or
a capability of the communication apparatus.

19. The communication apparatus of claim 18, wherein the BTC configuration information indicates at least one of:
an initial beam direction,
a sequence of beam switching instants, or
a sequence of beam indices corresponding to the sequence of beam switching instants.

20. The communication apparatus of claim 17, the operations further comprising:
receiving a parameter, wherein the parameter indicates at least one of:
an identification of an orbit of a given NT-TRP among the at least one NT-TRP,
maximum transition time for communication between the communication apparatus and the given NT-TRP, or
minimum transition period for communication between the communication apparatus and the given NT-TRP.

21. The communication apparatus of claim 17, wherein the communicating with the at least one NT-TRP comprises:
switching, at a switching time indicated in the BTC configuration information, from a first serving beam to a second serving beam according to the BTC configuration information.
